(19) United States
(12) Patent Application Publication
(10) Pub. No.: US 2009/0285070 A1
(43) Pub. Date: Nov. 19, 2009

(54) COPY-PROTECTED OPTICAL STORAGE MEDIA AND METHOD FOR PRODUCING THE SAME

(76) Inventor: Mohd Afendy Bin Mohd Aris, Kuala Lumpur (MY)

Correspondence Address: DARBY & DARBY P.C., P.O. BOX 770, Church Street Station, New York, NY, 10008-0770, US

(21) Appl. No.: 12/467,161

(22) Filed: May 15, 2009

Related U.S. Application Data
(60) Provisional application No. 61/053,933, filed on May 16, 2008.

(51) Int. Cl. G11B 19/04

(52) U.S. Cl. 369/53.21; G9B/19.005

(57) ABSTRACT

A method is provided for protecting and authenticating data (software programs, games etc) and media (video, audio) from an optical storage media from copyright infringement via a computing system or dedicated hardware while allow said content (especially media and audio) to perform as is on multimedia capable devices (dvd-players) without alteration or modification to the above-said multimedia devices. This method involves control of the layout of the optical disk structure, controlling access to the said layout and allowing for accurate identification of protected disks. It relies on the use of the optical media's lead-in area, program area and lead-out area all for storing certain portions of the system. An access control program is configured to determine access rights, the program area is encoded with data mapped in accordance to the layout scheme and for proper use on a computing system, a software application (layout control logic) is used to provide access to the data of the program area mapped in accordance with the layout scheme. During production of the optical media, the layout of the disc image is manipulated in accordance the layout scheme.

This application claims priority under 35 U.S.C. § 119 (e) to U.S. Provisional Patent Application Ser. No. 61/053,933, entitled “COPY-PROTECTED OPTICAL STORAGE MEDIA AND METHOD FOR PRODUCING THE SAME,” and filed May 16, 2008, the contents of which are hereby incorporated by reference as though set forth in its entirety.

### FIELD OF INVENTION

The present invention relates to a method and system for preventing the unauthorized duplication of data stored on an optical storage media and a method for manufacturing the same so as to prevent data duplication using controlled access, data layout, and encryption.

### BACKGROUND

Illegally copied software, Video CDs (VCD), CDs, DVDs, and games are increasingly available for purchase on the open market. Such illegally copied software (i.e., pirated software) is typically sold at discounted prices diverting sales from the legitimate manufacturer and distributor. As the cost of the copy is minimal, the purveyor of the illegal goods typically has a high profit margin. In many instances, the quality of some of the illegally produced optical media is identical to that of the original legitimate media. These factors have driven many consumers to turn from original to illegal pirated material.

Producers of original material have in the past attempted to prevent the copying itself. If copying can be prevented then the producers of VCDs, DVDs, CDs, computer games and software can achieve greater profits and realize greater economies of scale, thereby allowing the producers to reduce costs and offer the product at a lower price.

Currently, the price of original products is artificially increased to enable the producers to recover lost profits due to piracy and generate the income necessary to sustain their business. This is detrimental to the end users of original products and can encourage the consumption of cheaper pirated products. Preventing piracy will benefit both the consumer and the producer.

According to the IDSA (Interactive Digital Software Association), worldwide piracy is estimated to have cost the U.S. entertainment software industry over USD 3.0 billion in the year 2000 alone. The figure USD 3 billion does not even include losses attributable to Internet piracy, or losses in other major markets such as the Canada, Mexico, and Western Europe. A number of developers (both hardware and software based) have developed systems and/or applications to protect data. However, no universal system has been developed, and no multiplatform system has been developed that protects all ends of the content delivery chain.

Many DVDs, CDs and computer software packages currently incorporate some form of copy protection. Thus, copy protection is no longer an exception or novelty and is becoming more accepted and expected by the consumer and manufacturer. There is a wide range of techniques and programs involved when it comes to software protection including registration keys, serial numbers, dongles and Internet product activation. However, all these methods can be circumvented and frequently have been in the past. Frequently, once a copy protection scheme is circumvented, it can no longer protect any product that incorporates the particular scheme.

There is a need in the art for a multiplatform copy protection scheme which can prevent casual duplication of digital media. Additionally, a copy protection scheme that can be easily modified by the manufacturer so that circumventing a single instance of the copy protection does not render the entire copy protection scheme useless is also needed in the art.

### SUMMARY OF THE INVENTION

In accordance with one aspect of the present invention a copy-protected optical storage media is provided. The copy protected scheme involves control of the layout of the optical disk structure, controlling access to the said layout and allowing for accurate identification of protected disks. It relies on the use of the optical media's lead-in area, program area and lead-out area all for storing certain portions of the system. An access control program is configured to determine access rights, the program area is encoded with data mapped in accordance to the layout scheme and for proper use on a computing system, a software application (layout control logic) is used to provide access to the data of the program area mapped in accordance with the layout scheme.

In accordance with a further aspect of the present invention, a method for manufacturing a copy-protected optical storage media is provided. An optical disc image of the data to be distributed with the optical storage media is obtained and manipulated in accordance with a layout scheme to generate an updated disc image. The updated disc image is then converted to a burnable image using a predetermined optical disc format having a lead-in area, a program area, and a lead-out area, where the program area encodes the updated disc image. An access control program is embedded in burnable image, and a layout control logic is encoded in the lead-out area of the burnable image. The burnable image can then be printed to a blank optical storage media to produce the copy-protected optical storage media.

### BRIEF DESCRIPTION OF THE FIGURES

The foregoing and other features of the present invention will be more readily apparent from the following detailed description and drawings of the illustrative embodiments of the invention in which:

FIG. 1 illustrates an exemplary layout of an optical media storage in accordance with an embodiment of the present invention;

FIG. 2 illustrates a computing environment which can be used to manufacture optical media storage in accordance with an embodiment of the present invention; and

FIG. 3 is a flow diagram illustrating the process by which the optical media storage can be manufactured in accordance with an embodiment of the present invention;

FIG. 4 illustrates an exemplary screenshot of manufacturing control software made in accordance with an embodiment of the present invention;

FIG. 5 illustrates an embodiment of pseudo code of the software illustrated in FIG. 4 in accordance with an embodiment of the present invention;

FIG. 6 is a flowchart illustrating a process in accordance with one embodiment of the present invention; and

FIG. 7 illustrates an example of polymorphic code.

### DETAILED DESCRIPTION OF CERTAIN EMBODIMENTS

### Definitions

| | |
|---|---|
| API (Application | A functional interface supplied by the operating |
| Programming | system or by a separately licensed program that |
| Interface) | allows an application program written in a high- |
| | level language to use specific data or functions of |
| | an operating system or the licensed program. |
| | (IBM Dictionary of Computing, International |
| | Edition, 1994). An API is a set of programming |
| | language constructs or statements that can be |
| | coded in an application program to obtain the |
| | specific functions and services provided by the |
| | underlying operating system or service program. |
| Blu-Ray Disc | The name Blu-ray Disc is derived from the blue- |
| | violet laser used to read and write this type of |
| | disc. Because of its shorter wavelength (405 nm), |
| | substantially more data can be stored on a Blu-ray |
| | Disc than on the DVD format, which uses a red |
| | (650 nm) laser. A single layer Blu-ray Disc can |
| | store 25 gigabytes (GB), over five times the size |
| | of a single layer DVD at 4.7 GB. A dual layer |
| | Blu-ray Disc can store 50 GB, almost 6 times the |
| | size of a dual layer DVD at 8.5 GB. |
| CD-ROM | Compact disk read-only memory |
| Copy Protection | Refers to techniques used to prevent the |
| | unauthorized copying of software. The idea of |
| | copy-protected software was created by software |
| | manufacturers who wanted to prevent software |
| | piracy -- users copying programs and giving them |
| | to friends and colleagues free of charge. |
| DVD ROM | Digital Versatile Disk Read Only Memory |
| File Systems | This is the way in which files are named and |
| | where they are placed logically for storage and |
| | retrieval. The DOS, Windows, OS/2, Macintosh, |
| | and UNIX-based operating systems all have file |
| | systems in which files are placed somewhere in a |
| | hierarchical (tree) structure. A file is placed in a |
| | directory (folder in Windows) or subdirectory at |
| | the desired place in the tree structure. |
| File System | File System Recognizer knows enough about |
| Recognizer | each file system format that an Operating System |
| | supports to be able to examine a boot record and |
| | determine whether it's associated with a file |
| | system driver. |
| Image File | A compressed file that contains all the files |
| | required to populate a hard disk with applications |
| | and/or operating system. The image file is sent to |
| | multiple PCs and decompressed to their original |
| | state. |
| ISO9660 | An ISO 9660 file system is a standard CD-ROM |
| | file system that allows you to read the same CD- |
| | ROM whether you're on a PC, Mac, or other |
| | major computer platform. The standard, issued in |
| | 1988, was written by an industry group named |
| | High Sierra. |
| Kernel | The essential part of Unix or other operating |
| | systems, responsible for resource allocation, low- |
| | level hardware interfaces, security etc. |
| Metamorphic Code | Metamorphic code is code that can reprogram |
| | itself. Often, it does this by translating its own |
| | code into a temporary representation, and then |
| | back to normal code again. |
| Obfuscation | The concealment of intended meaning in |
| | communication, making communication |
| | confusing, intentionally ambiguous, and more |
| | difficult to interpret. |
| Operating System | The foundation software of a machine; that which |
| | schedules tasks, allocates storage, and presents a |
| | default interface to the user between applications. |
| Playstation Console | The leading family of games consoles, from Sony |
| | Corporation consisting of the original Playstation |
| | (PS1), the Playstation 2 (PS2), and the Playstation |
| | 3 (PS3). The basic Playstation consist of a small |
| | box containing the processor and a DVD reader, |
| | with video outputs to connect to a TV, sockets for |
| | at least two game controllers, and a socket for |
| | memory cards. |
| Poly-metamorphism | A poly-metamorphic engine is one that would |
| | take a piece of program code as input and |
| | perform mutations upon the original code to |
| | produce a resultant code piece that has exactly the |
| | same functions as the original program, but |
| | appears differently in individual instructions and |
| | sequences of code, during execution. |
| Polymorphism | A concept first identified by Christopher Strachey |
| | (1967) and developed by Hindley and Milner. It |
| | describes software code that mutates while |
| | keeping the original algorithm intact thereby |
| | enhancing the integrity and security of itself. |
| | (See attached figures for examples) |
| Private Key | An encryption system that uses two private keys |
| encryption | for encrypting and decrypting messages. Both |
| | parties must have a secret key to decrypt a |
| | message encrypted by the other. The drawback |
| | with this method of encryption is in the difficulty |
| | of distributing the private keys. |
| Public Key | is a type of cryptography also known as |
| encryption | asymmetric cryptography. It uses a unique |
| | Public/Private Key Pair of mathematically related |
| | numbers. The Public Key can be made available |
| | to anyone who wishes to use it, while its holder |
| | keeps the Private Key secret. Either key can be |
| | used to encrypt information or generate a Digital |
| | Signature, but only the corresponding key can |
| | decrypt that information or verify that Digital |
| | Signature. |
| Rootkit | A rootkit is a collection of tools (programs) that |
| | enable administrator-level access to a computer or |
| | computer network. |
| Software Piracy | Creating a copy and/or selling it. This is the act |
| | that some people refer to as “software piracy.” |
| | This is copyright infringement in most countries |
| | and is unlikely to be fair use or fair dealing if the |
| | work remains commercially available. |
| UDF (Universal Disk | A file system for optical media developed by the |
| Format) | Optical Storage Technology Association (OSTA), |
| | www.osta.org, based on the ECMA 167/ISO |
| | 13346 standard. It was designed for read-write |
| | interoperability among all the major operating |
| | systems as well as compatibility between |
| | rewritable and write-once media. DVDs are |
| | based on UDF, and it is an option for CD-Rs and |
| | CD-RWs. |
| UDF Bridge | UDF Bridge combines UDF and ISO 9660 for |
| | compatibility between both file systems. |
| Video CD | Standard method of storing video on a Compact |
| | Disc, playable in dedicated players and on |
| | personal computers. The VCD standard, agreed |
| | in 1993 by a consortium of Japanese electronics |
| | manufacturers and referred to as the White Book, |
| | involves storing MPEG-1 video as a track on an |
| | otherwise standard CD. |
| Video Game Console | A specialized desktop computer used to play |
| | video games. The three most popular game |
| | consoles are Sony's PlayStation 3 (PS3), |
| | Nintendo's GameCube and Microsoft's Xbox. |
| | Game software is available on CDs or DVDs, |
| | although earlier game machines used cartridges |
| | containing read only memory (ROM) chips. |
| | Video game consoles require a TV for display. |

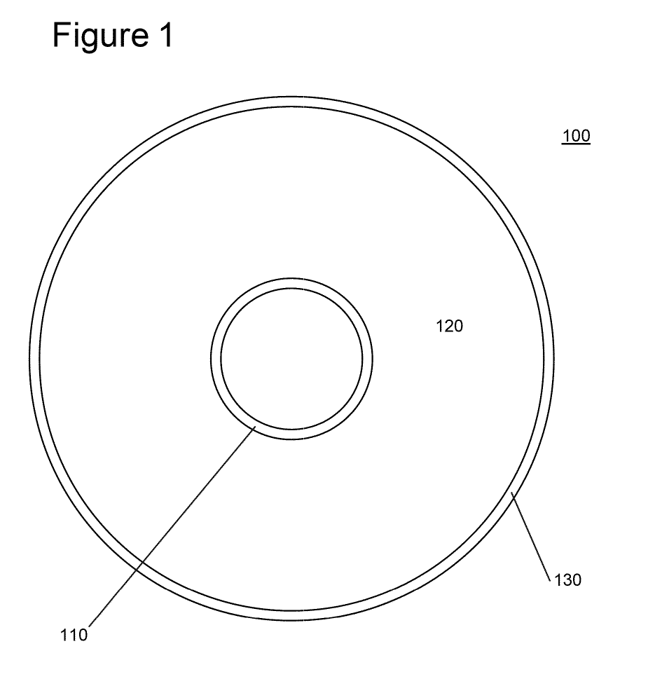

Referring now to the drawings, FIG. 1 illustrates an exemplary layout of an optical media storage device (i.e., optical disc) 100 produced in accordance with an embodiment of the present invention. The optical disc 100 includes a lead-in area 110, a program area 120 and a lead-out area 130. Each of the lead-in area 110, the program area 120 and the lead-out area 130 can be encoded with data by using systems and methods known by one of ordinary skill in the art. The encoding of data, keys or tables into the lead-in and lead-out areas of the optical storage media is can be achieved by manipulating directly an image file of an Optical Disk in need of protection. In this manner, optical disc 100 can be a CD-ROM, music CD, VCD, CD±R, CD±RW, DVD, DVD±R, Blu-Ray disc, HD-DVD, or other known standard optical storage medium.

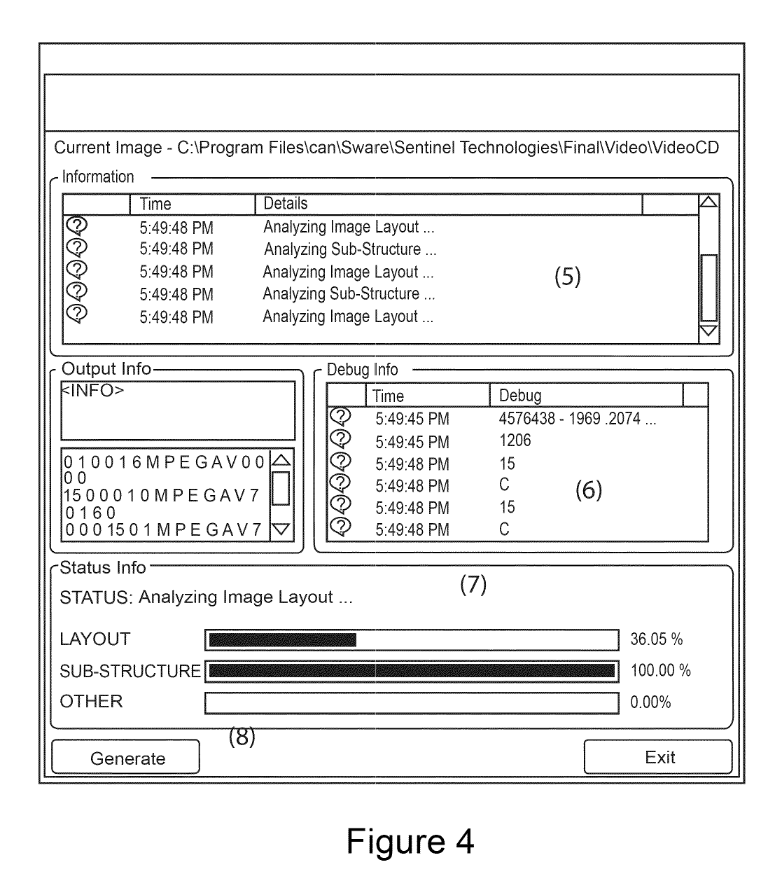

The present invention provides copy protection in part through a “wrapper software” for the protected media that acts as an access control program. The access control program enables a computer that is accessing the optical disc 100 to restrict the use and access of the optical disc 100 based on various parameters including the type of access, the user attempting access, or the software attempting access (i.e., DVD player software or CD copying software). The access control program can be programmed with almost any programming language, in this embodiment; it is developed in C++ as a combination of non-intrusive application software and driver combination. The sub-programs consisting of the access control program can be viewed in their native binary code format and thus stored in the appropriate location (using a disk editing tool or creating a custom program as displayed in FIG. 4) in the image file which is later converted to the final optical disc. The access control program is preferably stored immediately following the lead-in area 110 of the optical disc 100. However, it would be known by one of ordinary skill in the art that the access control program can be stored in other locations on the optical media or distributed across the optical media.

When a computer first access an optical disc, the computer examines the lead-in area 110 to read the table of contents of the disc, which is stored in the lead-in area 110. Thus, when a user inserts the optical disc 100 into a computer, the access control program is automatically installed, for example through an “autorun.inf” file in a MICROSOFT WINDOWS® environment. Similar autorun mechanisms are available in most computing environments. Once the access control program is installed, all accesses to the optical disc 100 are made through the access control program. In this manner, all access to the optical disc 100 can be controlled.

For example, if a user attempts to copy the optical disc 100, the access control program can detect the type of access being made to the disc (e.g., by profiling or other software identification). The access control program can actively respond (i.e., perform various protective measures) to the unauthorized access, for example, by denying access, terminating the process (i.e., the copying software) attempting to access the disc, or even shutting down computer. In some environments, it may be desirable to notify authorities of unauthorized attempts to copy the optical disc. For example, in a business environment, a system administrator may desire to be made aware of any attempts by employees to copy software licensed by the business. Thus, in such an environment, the access control program can be configured to obtain a configurable email address and send notification by email of the details surrounding the unauthorized copy attempt (e.g., time, date, software being accessed, copying software used, username of the user, computer ID, etc.).

Furthermore, when the protected optical disc 100 is removed from the computer, the access control program can delete, or even scrub, any temporary data associated with the optical disc 100 such as encryption keys and decrypted data stored elsewhere. Scrubbing temporary data is the act of encrypting the temporary data (or file) multiple times each with a random generated key, and then deleting the data. This is more secure to prevent the using of “un-delete” type utilities that can recover a file that has been simply deleted. Additionally, the access control program can uninstall itself, thereby leaving no or little information for a potential hacker to use to decode the protection mechanism of the optical disc.

The access control program can include additional deterrents and barriers to prevent reverse engineering of the program or bypassing of the protection scheme. For example, the software can include code-morphing technology that ensures that specific sections of code change each time it executes. Additionally, the access control program can include anti-trace codes and anti-debugger codes to prevent reverse engineering or execution tracing. To allow normal operation of the access control program and self-protection, the program itself would use encrypted strings and structures and obfuscation of its code thereby making it harder for a would-be-cracker to follow or understand the logical structure of the program.

Because DVD players and CD players are not desktop computing devices, these devices do not access the contents of DVDs or CDs in the same manner as a desktop computer. For example, the storage structure of a VIDEO-CD includes in the program area 120 video files that can be read (i.e., played) by a video-cd player. However, in order to read a VIDEO-CD on a personal computer, the VIDEO-CD must include a computer-readable filesystem and associated data structures (e.g., ISO 9660) that enable a personal computer to locate and retrieve the video file stored on the VIDEO-CD. In order for a personal computer to recognizing and accessing the filesystem and associated data structures, the access control program must be loaded.

Consumer devices, such as CD players and DVD players do execute the access control program. That is, consumer devices do not need to access the computer-readable filesystem and the remapping table to access the video files and are still able to play the content of the disc. However, the copy protection provided by the access control program is not required with respect to consumer devices because such devices are not capable of duplicating optical storage media, and thus, the restrictions of the access control program are not necessary to protect the contents of the disc.

The program area 120 of the disc is typically encoded with the data the user desires to access (e.g., software installation files, music files, movie files, etc.). The layout of the program area is determined by a layout scheme, which essentially remaps the location of data so that the data encoded in the program area can not be meaningfully read by a computer without knowledge of the layout scheme. A one-way hash based translation table will be used to store data information regarding files on the optical system. Numerous ways exist to develop the hash table as it is a custom data structure. In this current embodiment, the hash is calculated using information about the file sector location, the file name and the file size and is stored with a corresponding series of encryption keys (which has been used on the data file). By allowing a series of encryption keys tied directly to each entry in the hash table, it allows for segment encryption of the data files. It would be known by one of ordinary skill in the art that the segments in each file can be set at any arbitrary length dependent upon the writer of the decoding program.

The layout control logic controls aspects of retrieval of data file storage on the digital media. A computer can obtain the layout scheme by accessing a layout control logic that is encoded in the lead-out area 130 of the optical disc 100. Optionally, the layout control logic can include a remapping table or other known data structure encoding a portion of the layout scheme.

Requiring control of the retrieval of the data file, and storing the control logic in the lead-out area 130 increases the security of the data stored on the media because the lead-out area 130 (and the lead-in area 110) of the optical media is not copied in a standard optical media copy operation. Thus, even if a user is able to bypass the access control program of the optical disc 100, and copy the disc, the copy would most likely be inoperative.

In addition to the security provided by the access control program and storing the layout logic in the lead-out area 130, a copy of an optical disc made in accordance with the present invention would likely be unreadable due to the reordering of the data that occurs during a typically copy process. Data is stored on the optical media in sectors. During a conventional copy-and-burn process, sectors are read from the optical media and burned to a blank optical media. However, due to the practicalities of the copy-and-burn process, it is unlikely that the data from each sector of the original media will be written to the same sector at the same location on the new media. Thus, when a copy of the protected optical disc is accessed by a computer, the layout of the copied optical disc will not be identical to the layout of the protected/original optical disc, and the layout control logic of the copied optical disc will not correctly remap the data encoded in the program area 120 of the copied optical disc. Accordingly, copies of the protected optical disc cannot meaningfully be read and are unusable.

Each sector in an optical disk has several sections to it to allow for accurate retrieval of the sector information. It would be known by one of ordinary skill in the art that for every CD disk sector contains a sync field, header field, subheader field, data field, ECC P field, ECC Q field. Any changes in any of the afore-mentioned fields will result in unreadable data. By carefully modifying items in the field, the data residing in each sector can only be read through the access control application.

Additionally, encryption keys, encryption algorithms, hash based translation tables for directory traversal and optionally decryption keys for public/private encryption schemes, can be stored in the lead-in area 110 or interspersed in the header records of the sectors of the program data. That is, each sector of the program data includes a header portion that includes sector meta-data, such as information regarding how the data stored in the sector is linked to other sectors (e.g., identifying the next sector in the file). The header portion is typically divided into various fields. However, not all the fields of the header portion are used. Thus, these unused portions can be used to store encryption keys, encryption algorithms, optionally decryption keys, and other information used by the protection scheme

The encryption keys and encryption algorithms can be used to encrypt and decrypt the access control program. Each encryption/decryption key can be stored in a separate, pre-determined location for use within the multi-segmented encryption/decryption routines. Optionally, the encryption key can be unique for the processor. That is, for some families of processors (e.g., INTEL Core2 Quad Processors), the family can be uniquely identified. Thus, during creation of the protected media, each identifiable family can be associated with a code which is embedded in the software of the protection system. When the content of the optical medium is access, the protection system software can determine the identity of the processor and ensure that it matches the processor embedded in the protection system. If the code does not match, access to the content can be denied.

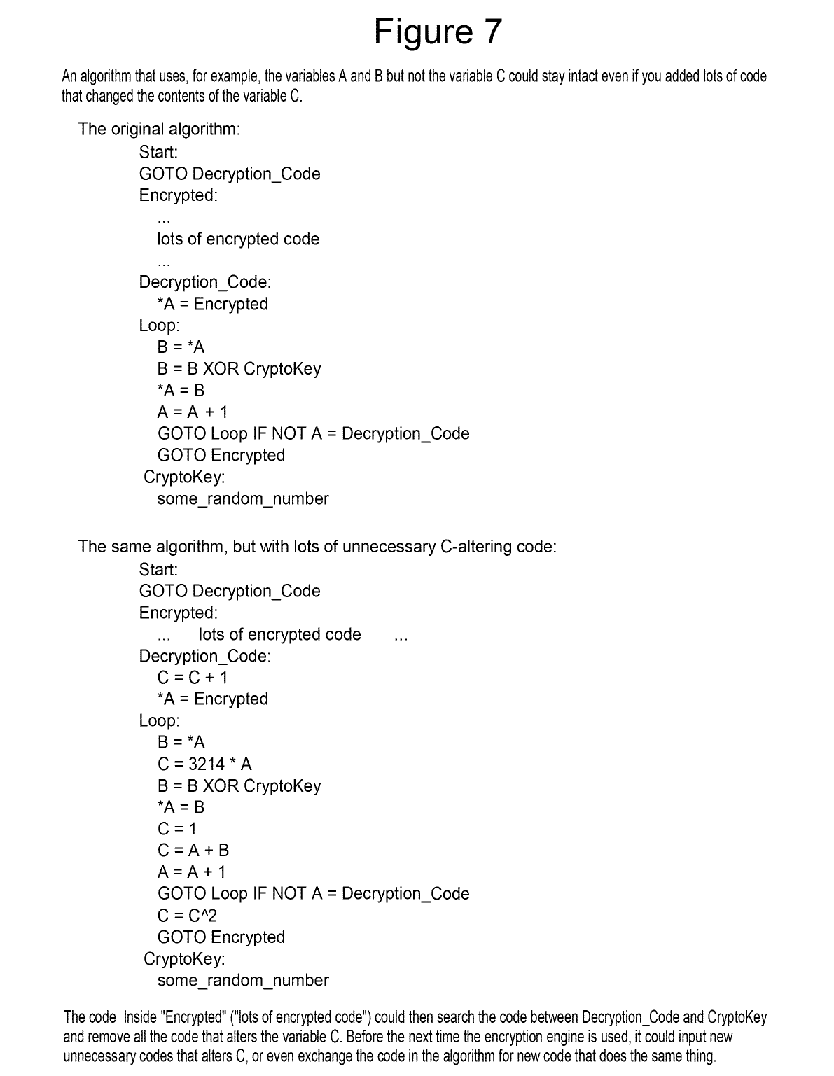

The access control program can optionally be encoded using multi-segmented encryption. That is, the access control program can be divided into predetermined self-contained instruction sets that are encrypted using a substantially unique encryption algorithm guaranteed via code polymorphism. An example of polymorphic code is illustrated in FIG. 7. This reduces the likelihood that any two binary instances of the access control program are identical. The substantially unique encryption algorithm corresponds to the substantially unique encryption algorithm of a processor adapted to decrypt and execute the encrypted self-contained instruction set. Preferably, the encryption algorithm utilizes a secret key algorithm for asymmetric encryption/decryption.

In a further aspect of the present invention, in multi-core or multi-processor computing systems, the system can be configured to execute non-encrypted software on a core or processor that is independent of the core or processor executing the encrypted access control program. Thus, when the protected optical disc is accessed on a computer, the computer obtains the encrypted self-contained instruction sets (i.e., the access control program) securely from the lead-in area.

Optionally, the access control program can be configured to access the encrypted instructions in multiple passes. That is, the executable instructions of the software can be accessed in segmented pieces so that there is no single computer read (i.e., access) of instructions that can be monitored by an individual trying to decode and/or bypass the system. Furthermore, executable instructions of the software can be stored in memory in separate memory spaces. Distributing instructions across multiple memory spaces avoids creating a single point of access by which a hacker can attempt to access and or crack the system.

Additionally, the encrypted self-contained instruction sets are decrypted by a separate secure processor and stored therein. Once any decrypted segment has completed execution, it can be encrypted again using a different instruction code and the secure memory process is removed. Thus, a potential pirate cannot access the encrypted portions of the executable software because each portion is only executed in an environment to which the pirate cannot obtain access. By encrypting the self-contained instruction sets uniquely for each digital media segment, unauthorized copying can be prevented.

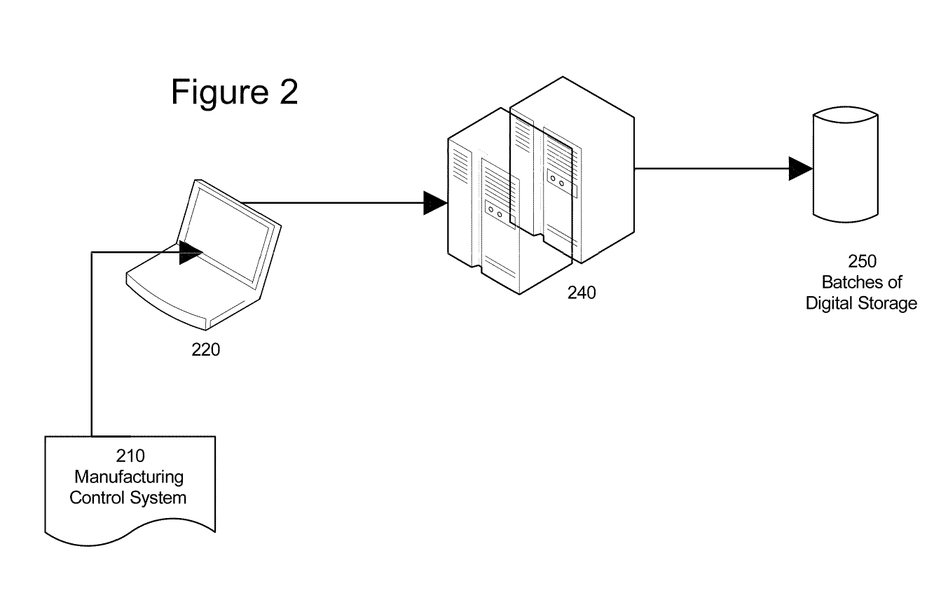

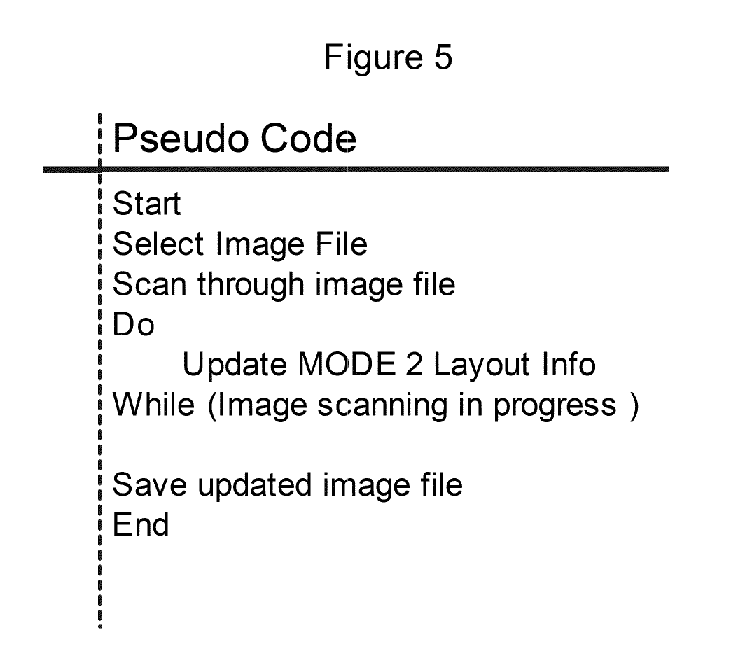

FIG. 2 illustrates a computing environment which can be used to manufacture optical media storage in accordance with an embodiment of the present invention. The environment includes a laptop 220, master installation software 210, a printing press machine 240 and storage media 250. The access control program and other information necessary to encode an optical disc in accordance with the present invention is stored in the manufacturing control system 210 and conveyed to the laptop 220 as necessary to print the optical discs 250 and the press machine 240. FIG. 4 illustrates a screenshot of manufacturing control system software made in accordance with one embodiment of the present invention. FIG. 5 illustrates pseudo-code of the software illustrated in FIG. 4.

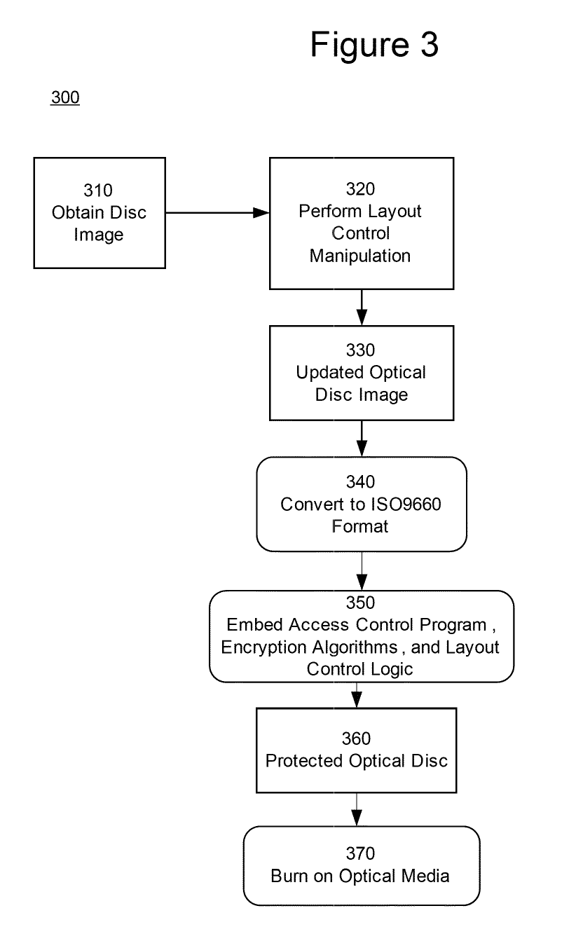

FIG. 3 is a flow diagram illustrating the process 300 by which optical media storage can be manufactured in accordance with an embodiment of the present invention. The data to be copied to the disc is obtained and formatted into an appropriate optical disc image at step 310. The manufacturing control system 210 manipulates the layout of the disc image at step 320 to produce an updated optical disc image at step 330. The optical disc image is then preferably converted to an ISO9660 format at step 340. However, it would be understood by one of ordinary skill in the art that any standard format (e.g., UDF) could be adapted for use in the present copy protection system.

The size of the disc image is preferably smaller than the maximum allowable size of the intended optical media by a predetermined amount. This size differential provides sufficient storage space to encode the access control program, encryption algorithms, layout control logic, and other data required by the copy protection system or meta-data.

The formatted optical disc image is then processed at step 350 to embed the access control program, encryption algorithms, and layout control logic. Thus, a protected optical disc image is produced at step 360. This image can then be burned onto optical media at step 370 by printing press 240. Preferably, for CDs embodying the present invention, the access control program is stored in CD-ROM Mode 1 format (i.e., 2,048 bytes/block), and the layout control logic is stored in CD-ROM Mode 2 format (i.e., 2,336 bytes/block).

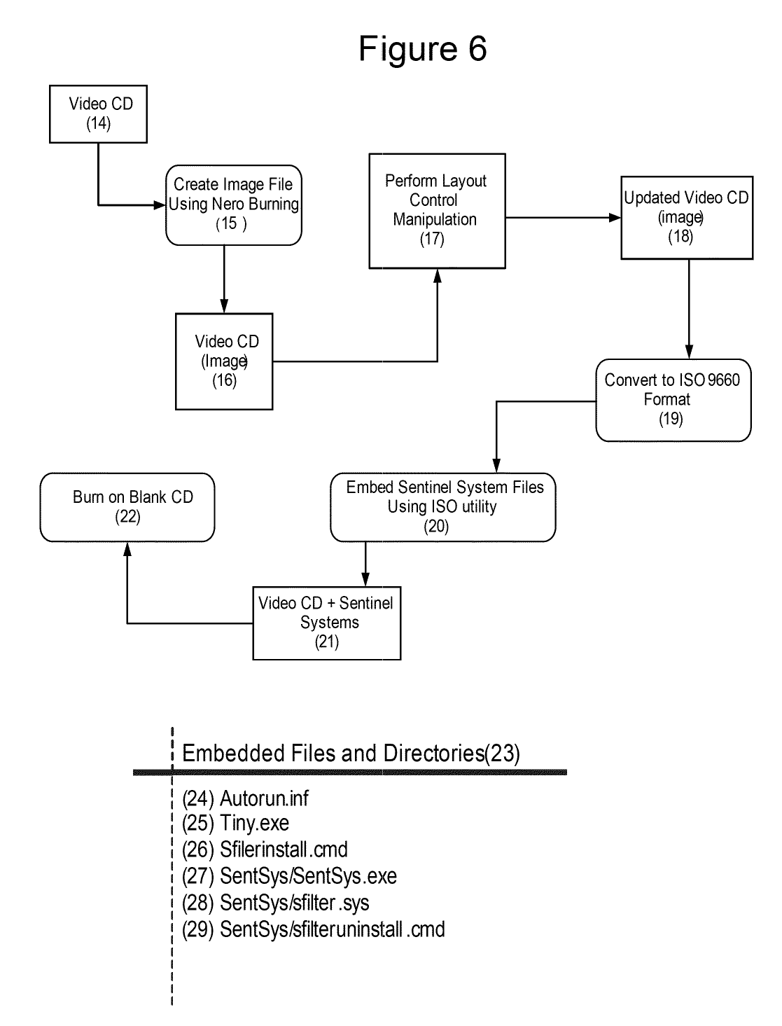

FIG. 6 illustrates an alternative embodiment of a process for manufacturing copy-protected optical discs, with particular reference to a VCD, in accordance with the present invention. A Video CD image file 603 is extracted from a Video CD 601 using a program such as NERO BURNING ROM 602. The image file obtained from the Video CD 601 is used as an input to the program displayed in FIG. 4.

The updated image file 605 can then be converted into a standard ISO9660 format, and using an ISO utility the following files and programs 610 can be embedded into the new ISO image file, which will then be burned onto a blank CD for the purposes of testing and verification.

When a user inserts the VCD into a CD/DVD ROM drive, the autorun.inf 611 is executed which executes the installation program ‘setup.exe’ 616. which in turn installs 613-616 on the user's computer. The programs 613, 614, 615 and 616 represent the installation and un-installation routines to allow the actual programs 613 and 615 to execute in accordance with one embodiment.

Programs 613 and 615 consist of the access and program control logic of copy protection system. These programs perform various tasks including allowing access to the protected media, actively prevent imaging software from duplicating the media, preventing hackers from bypassing secure information, and initiating the un-installation routines once the CD media has been ejected.

While the invention has been described in connection with a certain embodiment thereof, the invention is not limited to the described embodiments but it will be understood by those of ordinary skill in the art that that various changes in form and details may be made therein without departing from the spirit and scope of the invention.

I claim:

1. A copy-protected optical storage media comprising:
a lead-in area encoding a hash based table of contents;
a program area encoded with an access control program configured to determine access rights to the optical storage media and with data mapped in accordance with a predetermined layout scheme; and
a lead-out area encoded with a layout control logic, the layout control logic configured to enable a personal computer to access the mapped data of the program area in accordance with the layout scheme.

2. The copy-protected optical storage media of claim 1, wherein the lead-in area is further encoded with an encryption key, the program area data is encrypted with the encryption key, and the access control program is further configured to decrypt the program area data.

3. The copy-protected optical storage media of claim 1 wherein the access control program includes polymorphic code.

4. The copy-protected optical storage media of claim 1, wherein the lead-in area is further encoded with a portion of the access control program.

5. The copy-protected optical storage media of claim 1, wherein at least a portion of the access control program is encrypted.

6. The copy-protected optical storage media of claim 1, wherein the access control program includes at least one of anti-trace codes and anti-debugging codes.

7. The copy-protected optical storage media of claim 1, wherein the optical storage media is selected from the group consisting of a CD-ROM, DVD-ROM and a Blu-Ray Disc.

8. The copy-protected optical storage media of claim 1, wherein the access control program is further configured to actively respond to an attempt to copy the optical storage media.

9. A method for manufacturing a copy-protected optical storage media comprising the steps of:
obtaining data to be distributed with the optical storage media;
manipulating a layout of the data in accordance with a layout scheme;
generating an updated disc image;
converting the updated disc image to a burnable image using predetermined optical disc format having a lead-in area, a program area, and a lead-out area, the program area encoding the updated disc image;
embedding an access control program in the burnable image, the access control program configured to determine access rights to the optical storage media;
encoding a layout control logic in the lead-out area of the burnable image, the layout control logic configured to access the data of the program area in accordance with the layout scheme; and
printing the burnable image to a blank optical storage media to produce the copy-protected optical storage media.

10. The method of claim 9, further comprising the step of generating the access control program using polymorphic code.

11. The method of claim 9, further comprising the steps:
of encrypting at least a portion of the access control program using an encryption algorithm; and
embedding the encryption algorithm in the lead-in area of the burnable image.

12. The method of claim 9, wherein the lead-in area is further encoded with an encryption key, the program area data is encrypted with the encryption key, and the access control program is further configured to decrypt the program area data.

13. The method of claim 9, further comprising the step of encoding a portion of the access control program in the program area.

14. The method of claim 9, further comprising the step of encoding a portion of the access control program in the lead-in area.

15. The method of claim 9, wherein the access control program includes at least one of anti-trace code and anti-debugging code.

16. The method of claim 9 wherein the blank optical storage media is selected from the group consisting of a CD-ROM, DVD-ROM and a Blu-Ray Disc.

17. The method of claim 9, wherein the access control program is further configured to actively respond to an attempt to copy the copy protected optical storage media.

18. The copy-protected optical storage media of claim 1, wherein the layout control logic comprises a remapping table to encode at least a portion of the layout scheme.

19. The copy-protected optical storage media of claim 1, wherein the lead-in area is further encoded with a decryption key.

20. The copy-protected optical storage media of claim 1, wherein one or more of an encryption key, an encryption algorithm, and a decryption key are interspersed in one or more header records of the program area.

21. The copy-protected optical storage media of claim 1, wherein the access control program is encoded using multi-segmented encryption.

22. The copy-protected optical storage media of claim 1, wherein the access control program is configured to access encrypted instructions of the access control program by use of multiple passes.

23. A reader of a copy-protected optical storage media, the reader comprising:
an apparatus to read a lead-in area of the copy-protected optical storage media, the lead-in area encoding a table of contents;
an apparatus to read a program area of the copy-protected optical storage media, the program area encoded with an access control program configured to determine access rights to the optical storage media and with data mapped in accordance with a predetermined layout scheme; and
an apparatus to read a lead-out area of the copy-protected optical storage media, the lead-out area encoded with a layout control logic, the layout control logic configured to enable a personal computer to access the mapped data of the program area in accordance with the layout scheme.

24. The reader of a copy-protected optical storage media of claim 23, wherein the reader is configured to read an encryption key from the lead-in area of the copy-protected optical storage media, and to decrypt the program area data by use of the encryption key.

25. The reader of a copy-protected optical storage media of claim 23, wherein the apparatus to read a lead-in area is further configured to read at least a portion of the access control program.

26. The reader of a copy-protected optical storage media of claim 23, wherein the reader is configured to read at least one of anti-trace codes and anti-debugging codes.

27. The reader of a copy-protected optical storage media of claim 23, wherein the optical storage media is selected from the group consisting of a CD-ROM, DVD-ROM and a Blu-Ray Disc.

28. The reader of a copy-protected optical storage media of claim 23, wherein the reader is further configured to actively respond to an attempt to copy the copy-protected optical storage media.

29. A reader of an optical storage media, wherein the reader is configured to identify the optical storage media of claim 1.
